(19) United States
(12) Patent Application Publication
(10) Pub. No.: US 2015/0301736 A1
(43) Pub. Date: Oct. 22, 2015

(54) DISPLAY MODULE INCLUDING PHYSICAL BUTTON AND IMAGE SENSOR AND MANUFACTURING METHOD THEREOF

(71) Applicant: SAMSUNG ELECTRONICS CO., LTD., Suwon-si (KR)

(72) Inventors: Jae-Woo JUNG, Cheonan-si (KR); Tae-Sung JUNG, Seoul (KR); Myung-Koo KANG, Seoul (KR); Dong-Jae LEE, Osan-si (KR); Young-Wook HA, Seoul (KR)

(21) Appl. No.: 14/608,570

(22) Filed: Jan. 29, 2015

(30) Foreign Application Priority Data
Apr. 18, 2014 (KR) 10-2014-0046730

(51) Int. Cl. G06F 3/0488; G06F 3/02; G06F 3/042

(52) U.S. Cl. CPC G06F 3/04883; G06F 3/0425; G06F 3/021; G06F 2203/04103; G06F 2203/04808

(57) ABSTRACT

A display module and a method of manufacturing the same are provided. The display module includes a display panel, an image sensor layer stacked on the display panel, the image sensor layer responsive to a gesture, and a physical button layer stacked on the image sensor layer, the physical button layer to form a physical button.

### CROSS-REFERENCE TO RELATED APPLICATION

Korean Patent Application No. 10-2014-0046730, filed on Apr. 18, 2014, in the Korean Intellectual Property Office, and entitled: “Display Module Including Physical Button and Image Sensor and Manufacturing Method Thereof,” is incorporated by reference herein in its entirety.

### BACKGROUND

1. Field

Embodiments relate to a display module, for example, to a display module including a haptic physical button and an image sensor capable of sensing a gesture and a method of manufacturing thereof.

2. Description of Related Art

In a user interface (UI) or a user experience (UX), as the size of a display device increases, an area in addition to a display area may increase. Users are increasingly requesting increasing grip comfort by reducing the display area, and hardware components outside the display area may increase.

Various types of additional hardware, such as, for example, an image sensor or a home button, may require an additional area in addition to the display area in various products, such as, for example, a smart-phone or a tablet personal computer (PC).

### SUMMARY

Embodiments may be realized by providing a display module, including a display panel; an image sensor layer stacked on the display panel, the image sensor layer responsive to a gesture; and a physical button layer stacked on the image sensor layer, the physical button layer to form a physical button.

The image sensor layer may include at least one image sensor, and the image sensor may include an organic or quantum-dot-based material.

The display panel may include at least one driving circuit to operate a red pixel, a green pixel, and a blue pixel, and a black matrix masking the driving circuit.

The image sensor may be located over the black matrix.

The physical button layer may include a first polymer film stacked on the image sensor layer and a second polymer film stacked on the first polymer film, and the physical button layer may include a space that contains fluid between the first and second polymer films.

The display module may further include at least one fluid pump to move the fluid.

The physical button may perform a home button function of a mobile device and the fluid pump may form the physical button by moving the fluid.

The display panel may further include a touch sensing panel, the touch sensing panel responsive to a touch operation on the physical button.

Embodiments may be realized by providing a method of manufacturing a display module, the method including: forming a display panel; stacking an image sensor layer responsive to a gesture, on the display panel; and stacking a physical button layer, to form a physical button, on the image sensor layer.

Forming the display panel may include forming at least one driving circuit, the driving circuit to operate a red pixel, a green pixel, and a blue pixel; and forming a black matrix on the driving circuit.

The image sensor layer may include at least one image sensor, the image sensor may include an organic or quantum-dot-based material, and the image sensor may be located on the black matrix.

Stacking the physical button layer on the image sensor layer may include stacking a first polymer film on the image sensor layer; and stacking a second polymer film on the first polymer film. The physical button layer may include a space that contains fluid between the first and second polymer films.

The display module may further include at least one fluid pump to move the fluid.

The fluid pump may form the physical button on the display module by moving the fluid to the physical button.

The display panel may further include a touch sensing panel, the touch sensing panel responsive to a touch operation on the physical button.

Embodiments may be realized by providing a display module, including a display panel; and a button including liquid on the display panel.

The liquid may be a transparent liquid.

The display module may further include a button layer including a first polymer film, a second polymer film on the first polymer film, and a space between the first and second polymer films. The button may include liquid in the space between the first and second polymer films.

The display module may further include at least one liquid pump to move the liquid into the space between the first and second polymer films.

An electronic device, may include the display module; and an application processor to control the at least one liquid pump.

### BRIEF DESCRIPTION OF THE DRAWINGS

Features will become apparent to those of ordinary skill in the art by describing in detail exemplary embodiments with reference to the attached drawings in which:

FIG. 1A illustrates a smart-phone;

FIG. 1B illustrates a smart television (TV);

FIG. 2 illustrates a block diagram of the inside of a mobile device according to an embodiment;

FIG. 3A illustrates the mobile device shown in FIG. 2;

FIG. 3B illustrates the display module according to an embodiment;

FIG. 4A illustrates an internal configuration of a display module according to an embodiment;

FIG. 4B illustrates an internal configuration of a display module according to another embodiment;

FIGS. 5A to 5G illustrate a method of manufacturing of the display module shown in FIG. 2;

FIG. 6 illustrates a top view of the display module according to an embodiment;

FIG. 7 illustrates a physical button shown in FIG. 6;

FIG. 8 illustrates a flow chart of a method of manufacturing the display module according to an embodiment;

FIGS. 9A to 9K illustrate gestures according to an embodiment;

FIG. 10 illustrates a block diagram of an example of a computer system 210 that includes the display module illustrated in FIG. 2;

FIG. 11 illustrates a block diagram of another example of a computer system 220 that includes the display module illustrated in FIG. 2;

FIG. 12 illustrates a mobile device 300 including the display module shown in FIG. 2; and

FIG. 13 illustrates a display device 400 including the display module shown in FIG. 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

It will be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present.

Similarly, it will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “adjacent” versus “directly adjacent,” etc.).

It will also be understood that, although the terms “first,” “second,” “A,” “B,” etc., may be used herein in reference to elements, such elements should not be construed as limited by these terms. For example, a first element could be termed a second element, and a second element could be termed a first element. Herein, the term “and/or” includes any and all combinations of one or more referents.

The terminology used herein to describe embodiments is not intended to be limiting. The articles “a,” “an,” and “the” are singular in that they have a single referent, however, the use of the singular form in the present document should not preclude the presence of more than one referent. In other words, elements referred to in singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the relevant art. It will be further understood that terms in common usage should also be interpreted as is customary in the relevant art and not in an idealized or overly formal sense unless expressly so defined herein.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure) is illustrated in a cross-sectional view, an electronic device may include a plurality of the device structures (e.g., memory cell structures), as would be illustrated by a plan view of the electronic device. The plurality of device structures may be arranged in an array and/or in a two-dimensional pattern.

Meanwhile, when it is possible to implement any embodiment in any other way, a function or an operation specified in a specific block may be performed differently from a flow specified in a flowchart. For example, consecutive two blocks may actually perform the function or the operation simultaneously, and the two blocks may perform the function or the operation conversely according to a related operation or function.

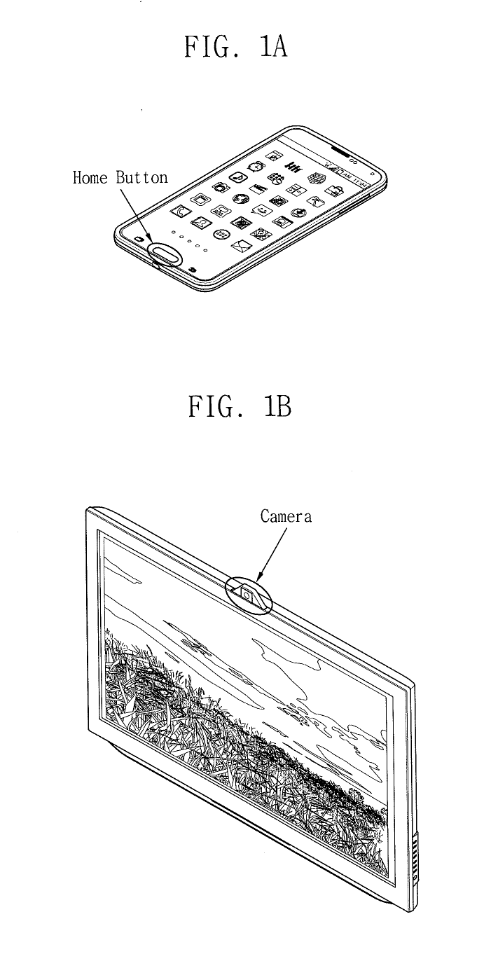

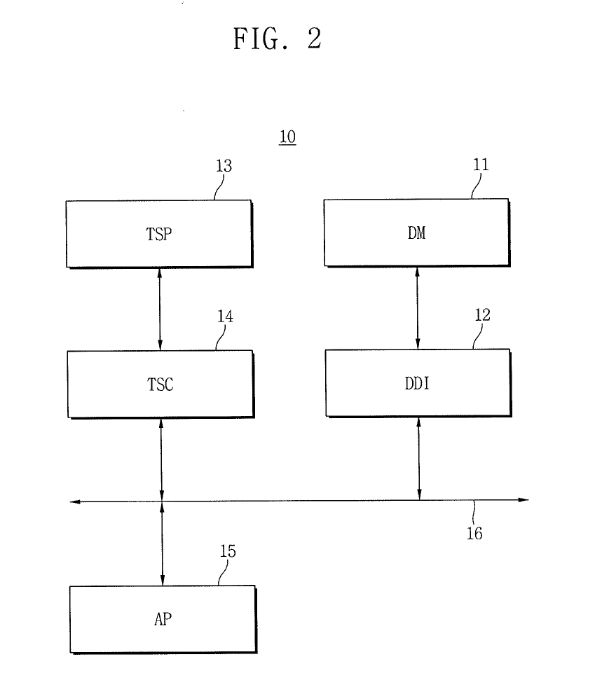

FIG. 1A illustrates a smart-phone, and FIG. 1B illustrates a smart TV.

Various types of additional hardware in various appliances, such as, for example, a smart-phone, a tablet personal computer (PC), or a smart TV, may require an additional area in addition to a display area. For example, special areas for hardware, such as, for example, an image sensor or a physical button, may be required in order to employ various functions in a smart-phone or a smart TV. For example, a home button may be mounted in a smart-phone as shown in FIG. 1A, and a camera device may be mounted in a smart TV as shown in FIG. 1B.

A display module according to an embodiment may include a physical button and an image sensor, and an additional area for an additional function, such as a home button function on a screen of a mobile device, may be reduced.

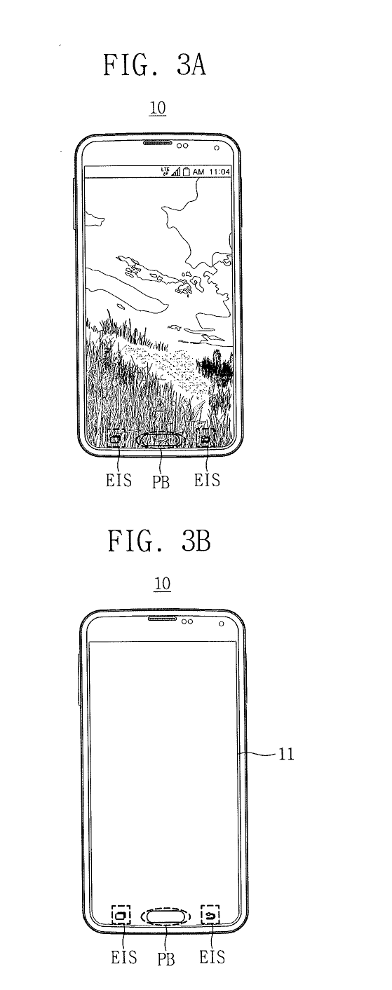

FIG. 2 illustrates a block diagram of the inside of a mobile device according to an embodiment.

Referring to FIG. 2, a mobile device 10 may include a display module (DM) 11, a display driver integrated circuit (DDI) 12, a touch sensing panel (TSP) 13, a touch sensor controller (TSC) 14, an application processor (AP) 15, and a system bus 16.

The DM 11 may be embodied, for example, in a liquid crystal display (LCD) or an active matrix organic light emitting diode (AMOLED). The DDI 12 may control the DM 11.

The TSP 13 may be mounted on a front surface of the mobile device 10 and may receive a touch signal from a user. The TSC 14 may control the TSP 13 and transmit touch input coordinate information to the DDI 12 or the AP 15 via the system bus 16.

In the TSP 13, metal electrodes may be stacked and distributed, a user may perform a touch operation on the TSP 13, and a capacitance level between the metal electrodes in the TSP 13 may change. The TSP 13 may transmit the changed capacitance level to the TSC 14. The TSC 14 may transform the changed capacitance level into X and Y axis coordinates and transmit the X and Y axis coordinates to the AP 15 or the DDI 12 via the system bus 16.

The system bus 16 may mutually connect the AP 15, the DDI 12, and the TSC 14, and may transmit data or a control signal among the AP 15, the DDI 12, and the TSC 14. In an embodiment, the system bus 16 may be, for example, an inter-integrated circuit (I2C) bus or a serial peripheral interface (SPI) bus, which may be used for communication between chips.

The AP 15 may control the DDI 12 or the TSC 14 via the system bus 16. In general, Exynos™ (Samsung Electronics Co., Ltd.), Snapdragon™ (Qualcomm® Inc.), or Tegra® 4 (Nvidia® Corp.) may be used as the AP in the mobile device 10.

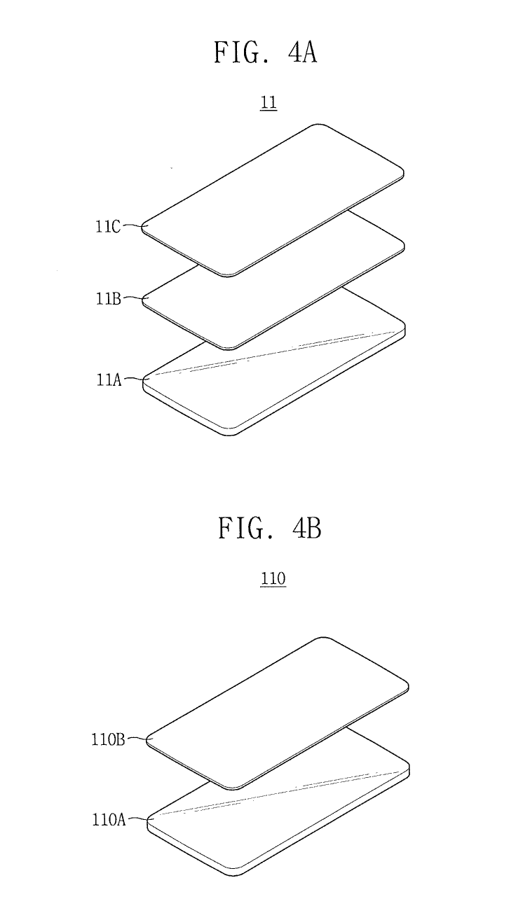

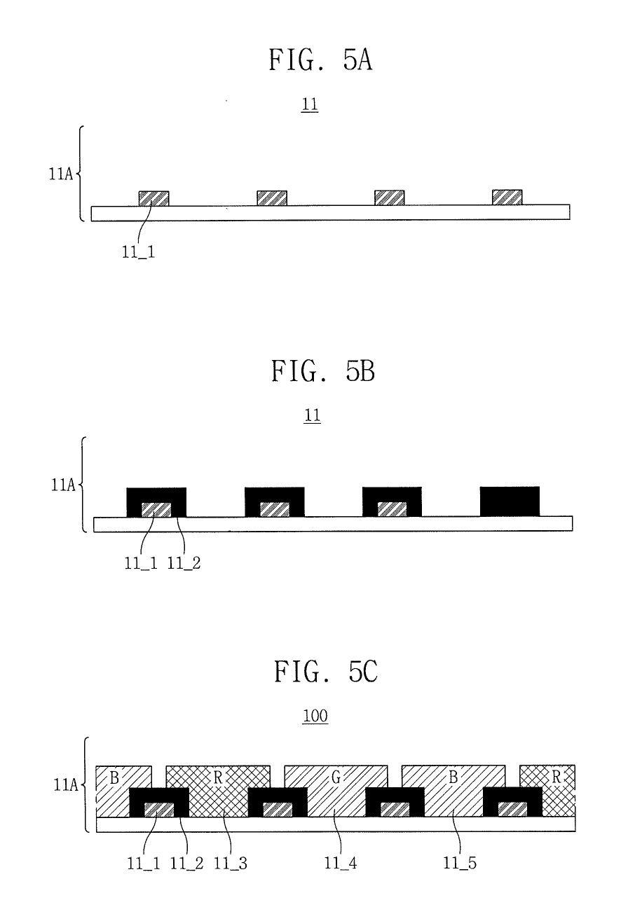

FIG. 3A illustrates the mobile device shown in FIG. 2.

Referring to FIG. 3A, a window cover glass may be mounted on a front surface of a mobile device 10. The display module 11 may be mounted under the window cover glass. The TSP 13 may be included in the display module 11 or attached on the display module 11. The mobile device 10 may include a smart-phone.

It may be desirable to increase the screen size of a display of a mobile phone 10, and to maintain grip comfort of a smart-phone. When a home button, which is a physical button, is mounted in the mobile device 10, an increase of the screen size of the mobile device 10 may be limited.

The display module 11 according to an embodiment may include a physical button PB to perform a home button function in the display panel 11. Further, the display module 11 may include an embedded image sensor (EIS) responsive to, e.g., to sense, a gesture from a user.

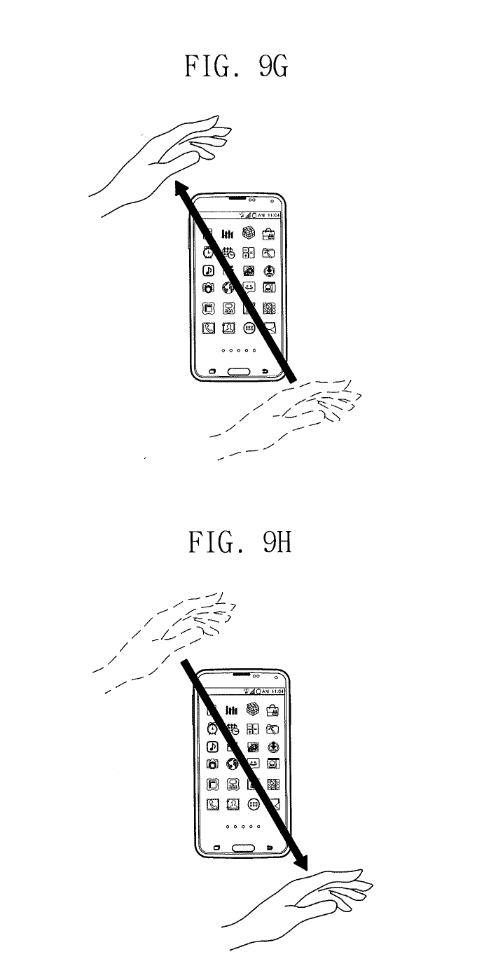

A camera device, which may photograph an image or a moving picture, may be mounted on a front surface or a rear surface of the mobile device 10. For example, the mobile device 10 may perform a video call or an application by using the camera device. In an embodiment, the embedded image sensor EIS in the display module 11 may sense a gesture from a user. The gestures will be described with reference to FIGS. 9A to 9K.

FIG. 3B illustrates the display module according to an embodiment.

Referring to FIG. 3B, in the mobile device 10, a home button may be embodied in hardware outside a display area because physical touch comfort may be important.

The display module 11 according to an embodiment may include a physical button PB and at least one embedded image sensor EIS. For example, the physical button PB may be located on the display module 11.

The physical button PB may provide physical touch comfort to a user. For example, when a specific application is executed, the physical button PB may be formed. For example, the display module 11 may inject transparent fluid (i.e., micro-fluid) to form the physical button PB.

Further, the display module 11 may include an image sensor responsive to, e.g., to sense, a near field movement. In an embodiment, the embedded image sensor EIS may include an organic or quantum-dot-based material, which may sense light by generating an electron-hole pair when absorbing light.

The embedded image sensor EIS in the display module 11 may sense a near field image or a movement (i.e., a gesture). In an embodiment, the embedded image sensor EIS may be included to each of the left and right of the physical button PB.

Further, the embedded image sensor EIS may be mounted to be uniformly distributed in the display module 11.

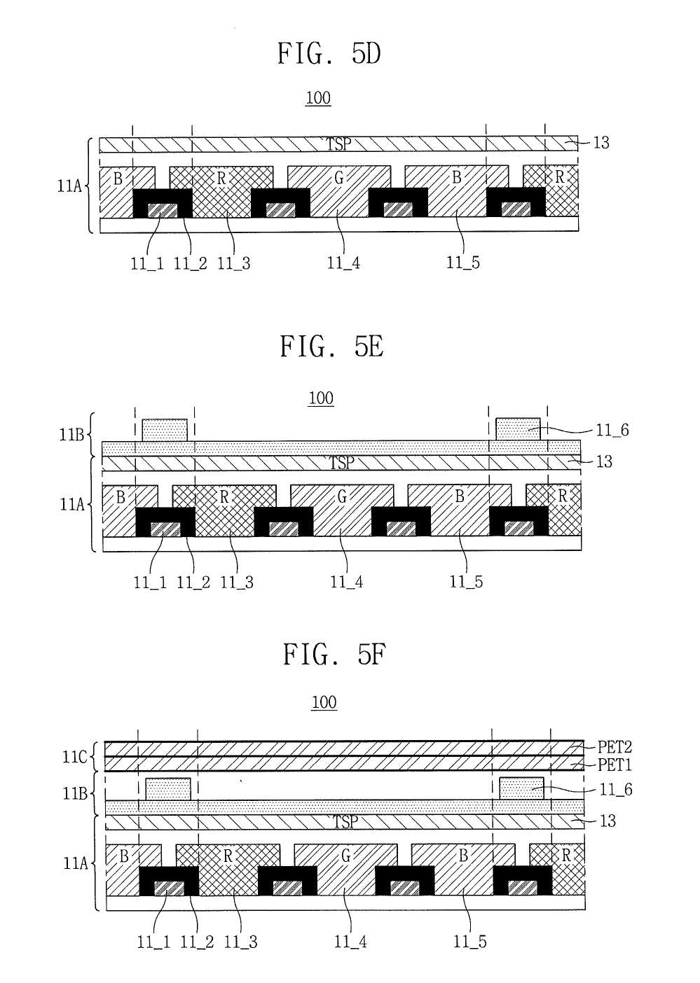

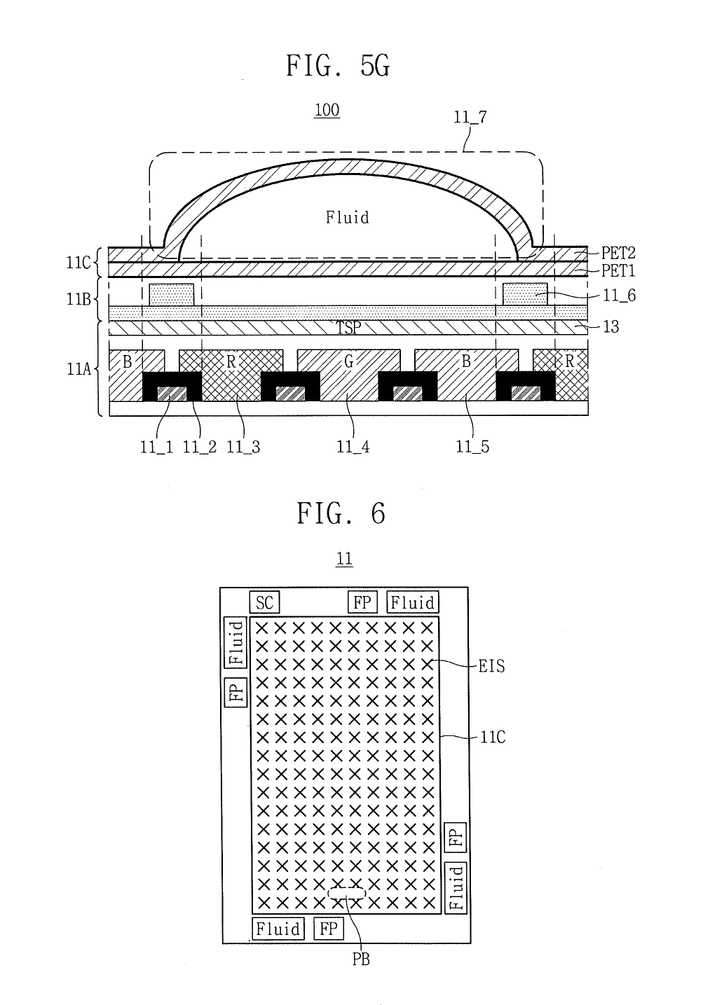

FIG. 4A illustrates an internal configuration of a display module according to an embodiment.

Referring to FIG. 4A, the display module 11 according to an embodiment may include a display panel 11A, an image sensor layer 11B, and a physical button layer 11C.

The display panel 11A may be disposed on the bottom. The image sensor layer 11B may be stacked on the display panel 11A. The physical button layer 11C may be stacked on the image sensor layer 11B.

FIG. 4B illustrates an internal configuration of a display module according to another embodiment.

Referring to FIG. 4B, the display module 110 according to another embodiment may include a display panel 110A, and a physical button layer 110B.

The display panel 110A may be disposed on the bottom. The display panel 110A may include an image sensor. The physical button layer 110B may be stacked on the display panel 110A.

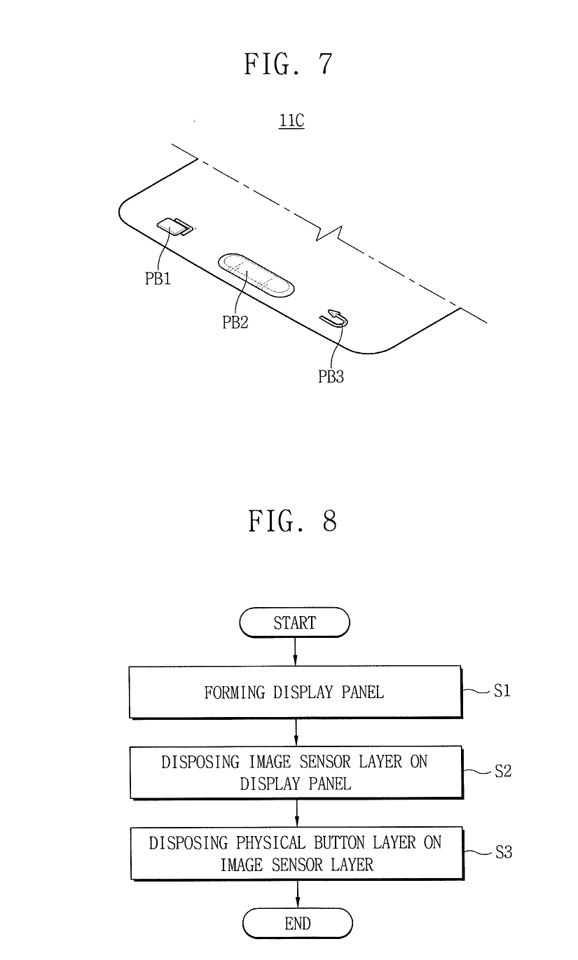

FIGS. 5A to 5G illustrate a method of manufacturing of the display module shown in FIG. 2.

Referring to FIGS. 2, 4A, and 5A, a method of manufacturing the display module 11 according to an embodiment may dispose a display panel 11A on the bottom, may dispose an image sensor layer 11B on the display panel 11A, and may dispose a physical button layer 11C on the image sensor layer 11B.

A driving circuit 11_1, which may drive a red pixel, a green pixel, and a blue pixel, may be formed in the display panel 11A.

Referring to FIGS. 2, 4A and 5B, a black matrix on array (BOA) process may be applied to the display panel 11A, and the driving circuit 11_1 may be prevented from appearing on a screen of the mobile device 10. For example, a black matrix 11_2 may be formed on the driving circuit 11_1. The black matrix 11_2 may be formed on the driving circuit 11_1. The black matrix 11_2 may prevent the driving circuit 11_1 from appearing on the display module 11.

Referring to FIGS. 2, 4A, and 5C, a R (i.e., red) pixel 11_3, a G (i.e., green) pixel 11_4, and a B (i.e., blue) pixel 11_5 may be formed in the display panel 11A. Each of the R pixel 11_3, the G pixel 11_4, and the B pixel 11_5 may be formed on the black matrix 11_2.

Referring to FIGS. 2, 4A, and 5D, the display panel 11A may include the TSP 13. Further, the TSP 13 may be stacked on the display panel 11A.

Referring to FIGS. 2, 4A, and 5E, the image sensor layer 11B may be formed on the display panel 11A. The image sensor layer 11B may include a plurality of image sensors 11_6 on glass. The plurality of image sensors 11_6 may be manufactured through a printing process.

In an embodiment, each of the plurality of image sensors 11_6 may include an organic or quantum-dot-based material. Each of the plurality of image sensors 11_6 may be formed over the black matrix 11_2, and degradation in picture quality generated, for example, by embedding the plurality of image sensors 11_6, may be reduced.

Referring to FIGS. 2, 4A, and 5F, the physical button layer 11C may be stacked on the image sensor layer 11B. The physical button layer 11C may include a first polyethylene terephthalate film PET1 stacked on the image sensor layer 11B and a second polyethylene terephthalate film PET2 stacked on the first polyethylene terephthalate film PET1. The physical button layer 11C may form, e.g., include, a space, which may contain fluid, between the first and second polyethylene terephthalate films PET1 and PET2.

Referring to FIGS. 2, 4A, and 5G, the physical button layer 11C may include at least one physical button 11_7. The physical button 11_7 may be formed by moving the fluid Fluid between the first and second polyethylene terephthalate films PET1 and PET2.

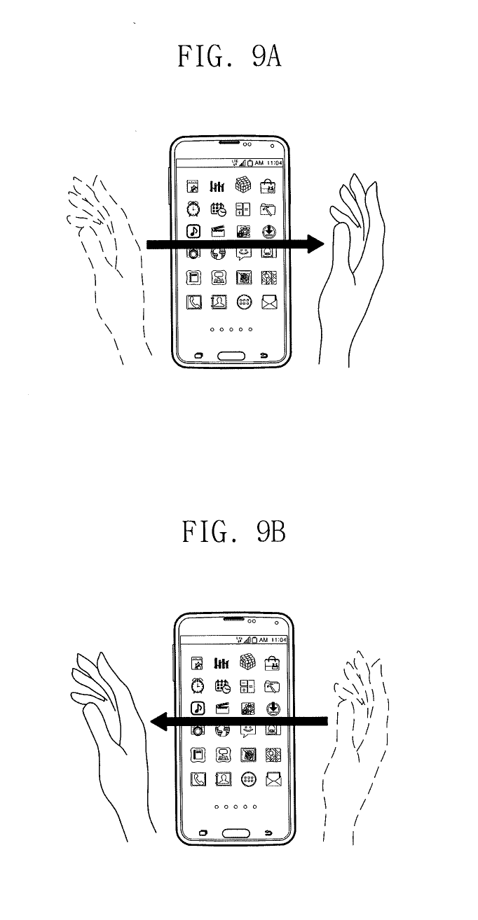

FIG. 6 illustrates a top view of the display module according to an embodiment.

Referring to FIGS. 2, 4A, and 6, the display module 11 may include a display panel 11A, an image sensor layer 11B, and a physical button layer 11C. The image sensor layer 11B may include a plurality of embedded image sensors EIS. Each of the embedded image sensors EIS may be uniformly distributed on the image sensor layer 11B. The image sensor layer 11B may further include a sensor chipset SC that may control the embedded image sensor EIS.

The sensor chipset SC may detect a change in an amount of light from the embedded image sensor EIS. The sensor chipset SC may transmit information about the detected change in the amount of light to the DDI 12 or the AP 15 through DDI 12. The DDI 12 or AP 15 may perceive a gesture based on the change in the amount of light.

The display module 11 may include a fluid pump FP for moving fluid Fluid to the physical button layer 11C. The fluid may be in a liquid or gas state. In an embodiment, the fluid pump FP may be controlled by the AP 15.

The fluid pump FP may move fluid. For example, the fluid pump FP may move the fluid from a space where the fluid is stored to a physical button. Accordingly, the display module 11 may form the physical button. Further, the fluid pump FP may move the fluid from a physical button to the space where the fluid is stored. Accordingly, the display module 11 may remove the physical button.

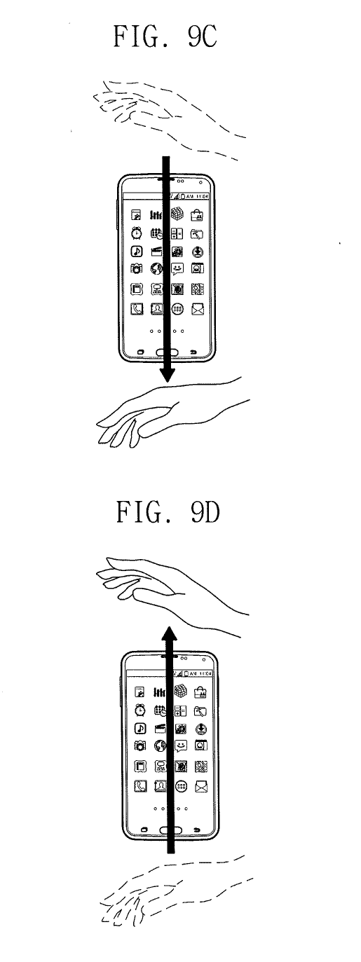

FIG. 7 illustrates a physical button shown in FIG. 6.

Referring to FIGS. 6 and 7, the physical button layer 11C may perform a home button function of the mobile device 10 or a switch function that may support, for example, a specific application. The physical button layer 11C may include a plurality of physical buttons. In an embodiment, the plurality of physical buttons may be uniformly distributed. Further, the plurality of physical buttons may be collectively distributed in a specific region.

Meanwhile, shapes of the plurality of physical buttons PB, which may be included in the physical button layer 11C, may be different from each other. The shapes of the physical buttons PB may be designed in a fabrication process in advance. Further, the shapes of the physical buttons PB may be diversely designed. For example, the physical buttons PB may include a first physical button PB1, a second physical button PB2, and a third physical button PB3.

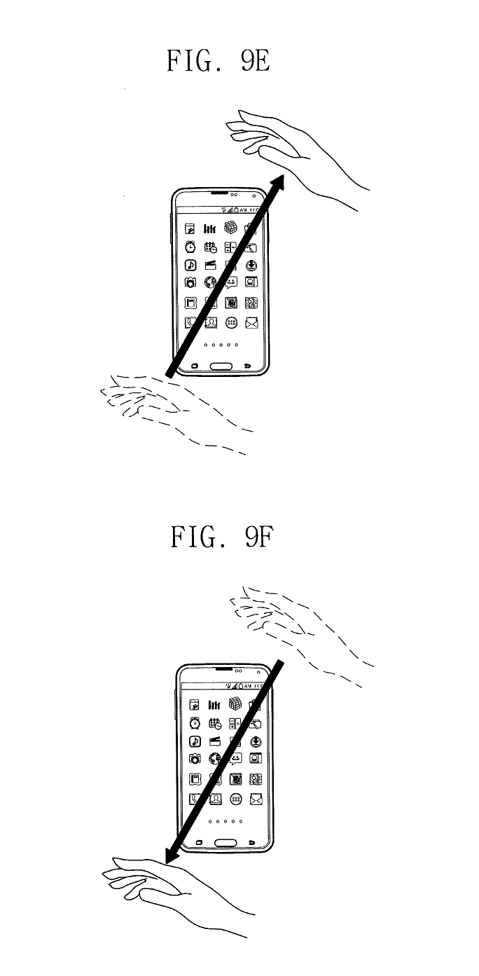

FIG. 8 illustrates a flow chart of a method of manufacturing the display module according to an embodiment.

Referring to FIGS. 5G and 8, In S1 operation, a method of manufacturing the display module 11 may include forming the display panel 11A.

For example, forming the display panel 11A may include forming at least one driving circuit 11_1, which may drive the display panel 11A, and forming a black matrix 11_2 on the at least one driving circuit 11_1.

In S2 operation, the method of manufacturing the display module 11 may include stacking the image sensor layer 11B, which may sense a gesture, on the display panel 11A.

The image sensor layer 11B may include at least one image sensor 11_6, and the image sensor 11_6 may include an organic or quantum-dot-based material. The image sensor 11_6 may be located over the black matrix 11_2.

In S3 operation, the method of manufacturing the display module 11 may include stacking a physical button layer 11C, which may generate a physical button 11_7, on the image sensor layer 11B.

The stacking of the physical button layer 11C may include stacking a first polyethylene terephthalate film PET1 on the image sensor layer 11B and stacking a second polyethylene terephthalate film PET2 on the first polyethylene terephthalate film PET1.

FIGS. 9A to 9K illustrate gestures according to an embodiment.

Referring to FIGS. 2 and 9A, a user may perform a gesture that moves a hand from left to right in front of the display module 11. The display module 11 may sense a change in an amount of light according to the gesture. The information about the change in the amount of light may be transmitted to the AP 15 through the DDI 12. For example, the AP 15 may convert a screen of the mobile device 10 into a next screen.

The user may perform a gesture moving quickly from left to right, and the AP 15 may convert the screen of the mobile device 10 into a screen after the next screen.

Referring to FIGS. 2 and 9B, a user may perform a gesture that moves a hand from right to left in front of the display module 11. The display module 11 may sense a change in an amount of light according to the gesture. The information about the change in the amount of light may be transmitted to the AP 15 through the DDI 12. For example, the AP 15 may convert a screen of the mobile device 10 into a previous screen.

The user may perform a gesture that moves quickly from right to left, and the AP 15 may convert a screen of the mobile device 10 into a screen before the previous screen.

Referring to FIGS. 2 and 9C, a user may perform a gesture that moves a hand from up to down in front of the display module 11. The display module 11 may sense a change in an amount of light according to the gesture. The information about the change in the amount of light may be transmitted o the AP 15 through the DDI 12. For example, the AP 15 may convert a screen of the mobile device 10 into a screen of the previously performed application.

Referring to FIGS. 2 and 9D, a user may perform a gesture that moves a hand from down to up in front of the display module 11. The display module 11 may sense a change in an amount of light according to the gesture. The information about the change in the amount of light may be transmitted to the AP 15 through the DDI 12. For example, the AP 15 may convert a screen of the mobile device 10 into the home screen.

Referring to FIGS. 2 and 9E, a user may perform a gesture that moves a hand from lower left to upper right in front of the display module 11. The display module 11 may sense a change in an amount of light according to the gesture. The information about the change in the amount of light may be transmitted to the AP 15 through the DDI 12. For example, the AP 15 may expand a screen of the mobile device 10.

Referring to FIGS. 2 and 9F, a user may perform a gesture that moves a hand from upper right to lower left in front of the display module 11. The display module 11 may sense a change in an amount of light according to the gesture. The information about the change in the amount of light may be transmitted to the AP 15 through the DDI 12. For example, the AP 15 may reduce a screen of the mobile device 10.

Referring to FIGS. 2 and 9G, a user may perform a gesture that moves a hand from lower right to upper left in front of the display module 11. The display module 11 may sense a change in an amount of light according to the gesture. The information about the change in the amount of light may be transmitted to the AP 15 through the DDI 12. For example, the AP 15 may expand a screen of the mobile device 10.

Referring to FIGS. 2 and 9H, a user may perform a gesture that moves a hand from upper left to lower right in front of the display module 11. The display module 11 may sense a change in an amount of light according to the gesture. The information about the change in the amount of light may be transmitted to the AP 15 through the DDI 12. For example, the AP 15 may reduce a screen of the mobile device 10.

Referring to FIGS. 2 and 9I, a user may perform a gesture in which a front of the display module 11 may be tapped using a finger. The display module 11 may sense a change in an amount of light according to the gesture. The information about the change in the amount of light may be transmitted to the AP 15 through the DDI 12.

For example, a user may tap once, and the AP 15 may activate a screen of the mobile device 10. The user may tap twice, and the AP 15 may deactivate a screen of the mobile device 10.

Referring to FIGS. 2 and 9J, a user may drag a finger clockwise in front of the display module 11. The display module 11 may sense a change in an amount of light according to the gesture. The information about the change in the amount of light may be transmitted to the AP 15 through the DDI 12. For example, the AP 15 may convert a screen of the mobile device 10 into a next screen.

Referring to FIGS. 2 and 9K, a user may drag a finger counterclockwise in front of the display module 11. The display module 11 may sense a change in an amount of light according to the gesture. The information about the change in the amount of light may be transmitted to the AP 15 through the DDI 12. For example, the AP 15 may convert a screen of the mobile device 10 into a previous screen.

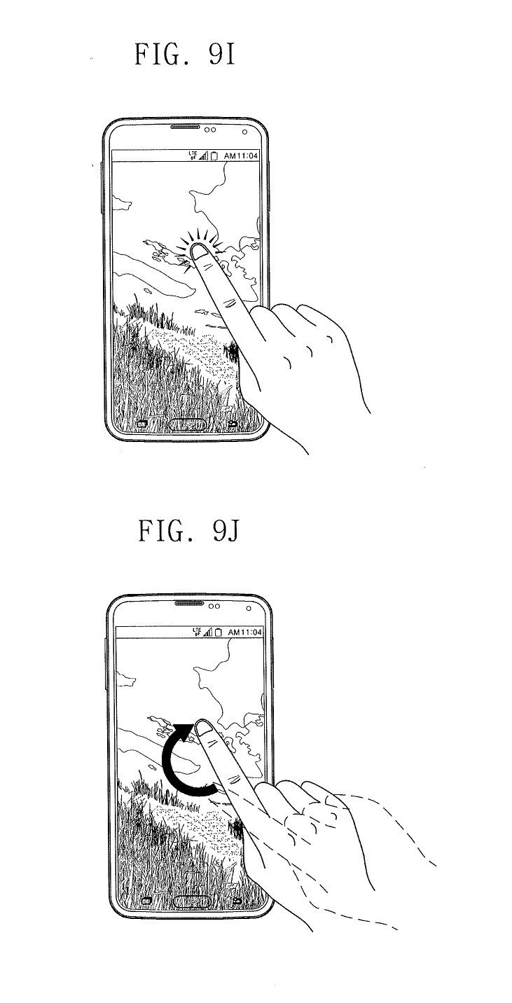

FIG. 10 illustrates a block diagram of an example of a computer system 210 that includes the display module illustrated in FIG. 2.

Referring to FIG. 10, the computer system 210 may include a memory device 211, an application processor (AP) 212 including a memory controller for controlling the memory device 211, a radio transceiver 213, an antenna 214, an input device 215, and a display device 216.

The radio transceiver 213 may transmit or receive a radio signal via the antenna 214. For example, the radio transceiver 213 may convert a radio signal received via the antenna 214 into a signal to be processed by the AP 212, and the AP 212 may process the radio signal output from the radio transceiver 213 and transmit the processed signal to the display device 216.

In an embodiment, the radio transceiver 213 may convert a signal output from the AP 212 into a radio signal and transmit the radio signal to an external device via the antenna 214.

The input device 215 may be a device through which a control signal for controlling an operation of the AP 212 or data to be processed by the AP 212 is input, and may be embodied as a pointing device, such as a touch pad or a computer mouse, a keypad, or a keyboard.

In an embodiment, the display device 216 may include the display module 11 shown in FIG. 2.

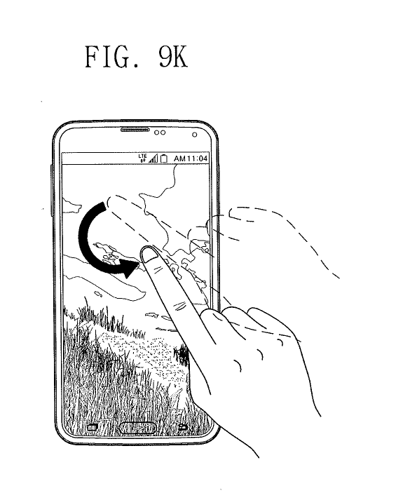

FIG. 11 illustrates a block diagram of another example of a computer system 220 that includes the display module illustrated in FIG. 2.

Referring to FIG. 11, the computer system 220 may be embodied as a PC, a network server, a tablet PC, a net-book, an e-reader, a personal digital assistant (PDA), a portable multimedia player (PMP), an MP3 player, or an MP4 player.

The computer system 220 may include a memory device 221, an AP 222 including a memory controller configured to control a data processing operation of the memory device 221, an input device 223, and a display device 224.

The AP 222 may display data stored in the memory device 221 on the display device 224 according to data input via the input device 223. For example, the input device 223 may be embodied as a pointing device, such as a touch pad or a computer mouse, a keypad, or a keyboard. The AP 222 may control overall operations of the computer system 220 and an operation of the memory device 221.

In an embodiment, the display device 224 may include the display module 11 shown in FIG. 2.

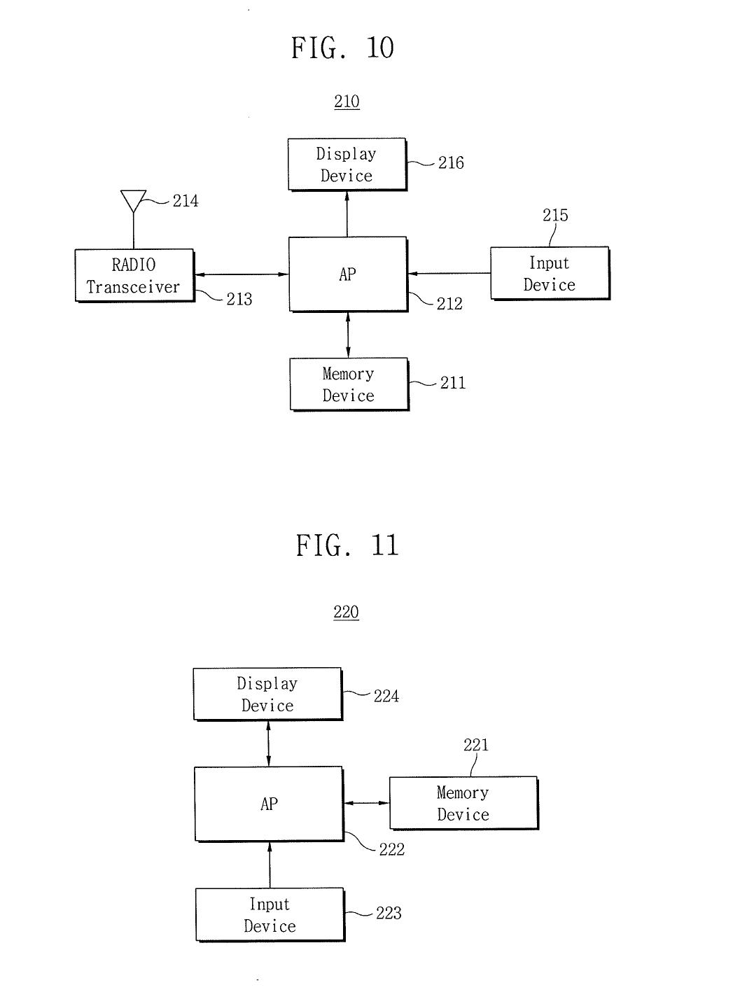

FIG. 12 illustrates a mobile device 300 including the display module shown in FIG. 2.

Referring to FIG. 12, a mobile device 300 may be a digital camera device that operates with an Android™ operating system (OS). In an embodiment, the mobile device 300 may include a Galaxy Camera™ or Galaxy Camera2™.

The mobile device 300 may include an image sensor that captures an image or a moving image and a display device 310 that displays a control panel for controlling the mobile device 300.

The mobile device 300 may reproduce an image or a moving image that is photographed through a wide display screen or an image or a moving image that will be photographed. The mobile device 300 may include an operational switch for photographing as well as a wide display screen.

In an embodiment, the display device 310 may include the display module 11 shown in FIG. 2.

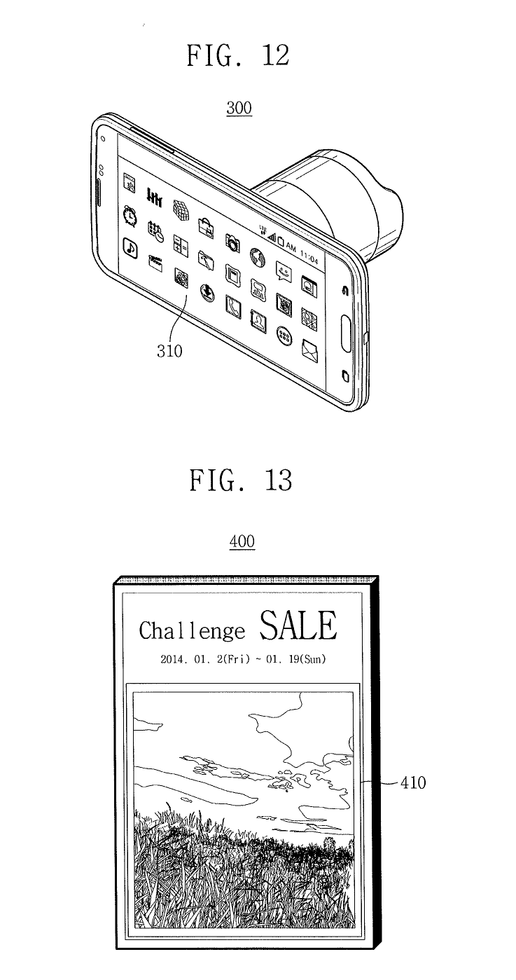

FIG. 13 illustrates a display device 400 including the display module shown in FIG. 1.

Referring to FIG. 13, the display device 400 may be embodied, for example, in a smart TV, a monitor, or other various types of mobile devices.

The display device 400 may include a large-sized and high-quality display panel. Further, the display device 400 may reproduce a 3-dimensional (3D) image.

In a department store or a shopping mall, the display device 400 may display a visual advertisement. A touch sensing panel may not be embedded in a large-sized display device 400, and a consumer may not select a desired advertisement.

An image sensor 410 may be embedded in the large-sized display device 400, and the consumer may select an advertisement or obtain additional information about the advertisement by inputting a gesture to the image sensor 410. In an embodiment, the display device 400 may include the display module 11 shown in FIG. 2.

By way of summation and review, a mobile apparatus may have a wide display whose size may be five inches or more. In addition, a home button, a front-side camera device, and various types of sensors may be mounted on another area other than the area of the display of the mobile apparatus. For example, an additional area other than the area of the display may be required in various products, such as, for example, a smart phone or a tablet PC, due to, for example, the image sensors or the home button.

A display module according to an embodiment may embed the image sensor or a physical button, such as the home button, therein. For example, the display module according to an embodiment may include a display panel, an image sensor layer stacked on the display panel, and a physical button layer stacked on an upper end of the image sensor layer, the physical button layer to form a physical button.

The image sensor layer according to an embodiment may be configured to recognize gestures, e.g., in combination with an application processor, as described above. The physical button layer according to an embodiment may be configured to generate, e.g., form, a physical button, e.g., in combination with an application processor, as described above. The display module according to an embodiment may perform a function of the home button and recognize the gestures, e.g., in combination with an application processor, as described above.

Embodiments provide a display module including a haptic physical button and an image sensor capable of sensing a gesture, e.g., in combination with an application processor, as described above. A display module according to an embodiment may perform a home button function or recognize a gesture, e.g., in combination with an application processor, as described above. Provided is an electronic device, e.g., a mobile device or a display device, including the display module. Other embodiments provide a method of manufacturing the display module.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A display module, comprising:
a display panel;
an image sensor layer stacked on the display panel, the image sensor layer responsive to a gesture; and
a physical button layer stacked on the image sensor layer, the physical button layer to form a physical button.

2. The display module as claimed in claim 1, wherein the image sensor layer includes at least one image sensor, and the image sensor includes an organic or quantum-dot-based material.

3. The display module as claimed in claim 2, wherein the display panel includes:
at least one driving circuit to operate a red pixel, a green pixel, and a blue pixel, and
a black matrix masking the driving circuit.

4. The display module as claimed in claim 3, wherein the image sensor is located over the black matrix.

5. The display module as claimed in claim 1, wherein the physical button layer includes a first polymer film stacked on the image sensor layer and a second polymer film stacked on the first polymer film, and the physical button layer includes a space that contains fluid between the first and second polymer films.

6. The display module as claimed in claim 5, further comprising at least one fluid pump to move the fluid.

7. The display module as claimed in claim 6, wherein the physical button performs a home button function of a mobile device and the fluid pump forms the physical button by moving the fluid.

8. The display module as claimed in claim 7, wherein the display panel further includes a touch sensing panel, the touch sensing panel responsive to a touch operation on the physical button.

9. A method of manufacturing a display module, the method comprising:
forming a display panel;
stacking an image sensor layer responsive to a gesture, on the display panel; and
stacking a physical button layer, to form a physical button, on the image sensor layer.

10. The method as claimed in claim 9, wherein forming the display panel includes:
forming at least one driving circuit, the driving circuit to operate a red pixel, a green pixel, and a blue pixel; and
forming a black matrix on the driving circuit.

11. The method as claimed in claim 10, wherein the image sensor layer includes at least one image sensor, the image sensor includes an organic or quantum-dot-based material, and the image sensor is located on the black matrix.

12. The method as claimed in claim 9, wherein stacking the physical button layer on the image sensor layer includes:
stacking a first polymer film on the image sensor layer; and
stacking a second polymer film on the first polymer film,
the physical button layer including a space that contains fluid between the first and second polymer films.

13. The method as claimed in claim 12, wherein the display module further includes at least one fluid pump to move the fluid.

14. The method as claimed in claim 13, wherein the fluid pump forms the physical button on the display module by moving the fluid to the physical button.

15. The method as claimed in claim 9, wherein the display panel further includes a touch sensing panel, the touch sensing panel responsive to a touch operation on the physical button.

16. A display module, comprising:
a display panel;
a button including liquid on the display panel; and
a button layer including a first polymer film, a second polymer film on the first polymer film, and a space between the first and second polymer films,
wherein the button includes liquid in the space between the first and second polymer films, and the liquid is a transparent liquid.

17. The display module as claimed in claim 16, further comprising:
at least one liquid pump to move the liquid into the space between the first and second polymer films.

18. An electronic device, including:
the display module as claimed in claim 17; and
an application processor to control the at least one liquid pump.
